(19) United States
(12) Patent Application Publication
(10) Pub. No.: US 2011/0037208 A1
(43) Pub. Date: Feb. 17, 2011

(54) GAS SPRING WITH SPEED CONTROL FUNCTION

(75) Inventor: Young-Sang JUN, Siheung-si (KR)

Correspondence Address: LOWE HAUPTMAN HAM & BERNER, LLP, 1700 DIAGONAL ROAD, SUITE 300, ALEXANDRIA, VA, 22314, US

(73) Assignee: KOREA GAS SPRING CO., LTD., Incheon (KR)

(21) Appl. No.: 12/853,750

(22) Filed: Aug. 10, 2010

(30) Foreign Application Priority Data
Aug. 12, 2009 (KR) 10-2009-0074358

(51) Int. Cl. F16F 9/02; F16F 9/32

(52) U.S. Cl. 267/114

(57) ABSTRACT

In a gas spring which includes a cylinder member slide-engaged in upward and downward directions in the interior of an outer body, an inner pipe which is engaged to an inner wall of the cylinder member and forms a gas flow path in upward and downward directions between itself and the inner wall of the same, a valve member which is provided in the upper sides of the cylinder member and the inner pipe and includes a gas guide flow path for controlling the flow of gas via the gas flow path depending on an operation of a valve pin, and a piston rod of which a head part is air-tightly slide-engaged in the interior of the inner pipe, and a rod part is vertically rotatably engaged to a bottom of the outer body, there is provided a gas spring with a speed control function which comprises a speed control guider disposed between a head part provided on an upper side of the piston rod and the valve member for thereby controlling the flow of a gas via a gas flow path when the cylinder member is lowered, which leads to controlling a lowering speed. The present invention is basically directed to allowing a user to sit on a chair without feeling an impact which might occur due to the lowering of a seat plate of a chair with a gas spring adapted to control the height of a chair.

### TECHNICAL FIELD

The present invention relates to a gas spring, and in particular to a gas spring with a speed control function by means of which a user can sit on a chair in a more comfortable way without noticing any impact or with a smooth cushioning force by obtaining a slowdown operation at a Bottom Dead Center (BDC) or a certain position when a seat plate is lowered in a chair with a gas spring used for controlling the height of a chair.

### BACKGROUND ART

A gas spring is generally applied to a height control structure of a seat plate of a chair for thereby efficiently raising and lowering a seat plate with the help of a gas pressure depending on a user's selection.

As shown in FIG. 1, a conventional spring conventionally called a gas cylinder includes an outer body 10 vertically installed in a base provided on the round, a cylinder member 20 which is slide-inserted and moves up and down along an inner surface of the outer body 10, a piston rod 30 which is engaged to the cylinder member 20 and moves up and down and raises and lowers the cylinder member 20 as an exposed end of the same is rotatably fixed in a bottom surface of the outer body 10 and moves up and down, a valve member 40 which is engaged to an upper side of the cylinder member 20 for thereby circulating a gas through a gas flow path, a valve pin which is inserted in the valve member 40 in an axial direction for thereby opening and closing a gas flow path, an opening and closing lever or a button connected with an upper side end of the valve pin for thereby raising and lowering the valve pin when moving up and down, and an operation lever for operating the opening and closing lever or the button.

In an inner side of the cylinder member 20 is provided an inner side pipe 70, so a gas flows toward the spaces of the upper and lower sides of the cylinder member 20 through a gap formed between the inner side pipe 70 and the cylinder member 20.

The gas is filled in the spaces of the upper and lower sides about the piston of the piston rod 30, and the gas flows through the gap depending on an opening and closing operation of a gas flow path formed in the valve member 40.

In a bottom surface of the outer body 10 is provided a rotary member 60 for thereby allowing a rod end of the piston rod 30 to rotate. A damper 50 is installed in the rotary member 60 for thereby absorbing an impact when the cylinder member 20 moves down.

As well known in the conventional art, the gas spring is generally applied to a chair for raising and lowering a seat plate as a cylinder member 20 is raised or lowered with the help of a piston rod 30 depending on a user's operation. The damper 50 contacts with a bottom dead center when the cylinder member 20 is lowered, so a user does not receive any impact with the help of a gas cushioning effect between the cylinder member 20 and the piston rod 30.

However, in the conventional gas spring, when a user sits in a state that the seat plate of the chair is positioned at the most lower position, namely, the bottom dead center, the cylinder member 20 contacts with the damper 50 made of a rubber material as the cylinder member 20 is lowered. At this moment, a certain level of an instant contact force occurs, which directly leads to an impact noise and a repulsive force. A lot of noises occur around the chair, and a user, who sits on the chair, feels a lot of impact forces.

The damper 50 supports the lowering cylinder member 20. Since a compressing distance of the damper is short, an impact repulsive force occurs, so a user directly receives such a repulsive force causing a lot of uneasiness when sitting on a chair.

Since the operation for adjusting the height of the seat plate is repeatedly performed, the cylinder member continues to hit the damper, so the damper is fast damaged, and it is needed to exchange the gas spring more frequently.

### DISCLOSURE OF THE INVENTION

Accordingly, it is a first object of the present invention to provide a gas spring with a speed control function by means of which a user can sit on a chair in a more comfortable way without noticing any impact noise or with a smooth cushioning force by obtaining a slowdown operation at a bottom dead center or a certain position when a seat plate is lowered in a chair with a gas spring used for controlling the height of a chair.

It is a second object of the present invention to provide a gas spring with a speed control function for automatically controlling a lowering speed of a seat plate without performing a specific operation when a seat plate is being lowered.

It is a third object of the present invention to provide a gas spring with a speed control function for continuously providing a cushioning force to a user when a seat plate is positioned at the bottom dead center when the seat plate is being lowered.

To achieve the above objects, in a gas spring which includes a cylinder member slide-engaged in upward and downward directions in the interior of an outer body, an inner pipe which is engaged to an inner wall of the cylinder member and forms a gas flow path in upward and downward directions between itself and the inner wall of the same, a valve member which is provided in the upper sides of the cylinder member and the inner pipe and includes a gas guide flow path for controlling the flow of gas via the gas flow path depending on an operation of a valve pin, and a piston rod of which a head part is air-tightly slide-engaged in the interior of the inner pipe, and a rod part is vertically rotatably engaged to a bottom of the outer body, there is provided a gas spring with a speed control function which comprises a speed control guider disposed between a head part provided on an upper side of the piston rod and the valve member for thereby controlling the flow of a gas via a gas flow path when the cylinder member is lowered, which leads to controlling a lowering speed.

The speed control guider includes a contact cap which forms a gas flow path for flowing gas and selectively contacts in a upper side or a lower side in a lower surface of the valve member; and a spacer member which is disposed between the lower surface of the contact cap and the piston rod for thereby maintaining a certain space.

The open groove upwardly open is formed in an upper surface of a body belonging to the contact cap for thereby guiding a valve pin without any interference when contacting with the valve member and a ring groove is formed in a lower surface and is downwardly open for fixedly inserting an upper end of the spacer member.

The body is made of one selected from the group consisting of metal, aluminum, zinc, synthetic resin and rubber.

The body is formed of an upper part and a lower part of which the lower part is made of a harder material and the upper part is made of a smoother material.

The spacer member is formed of a coil type spring or a rubber hollow cushioning material, and the spacer member is formed of a protrusion protruded from an inner wall of the inner pipe for controlling a downward movement of the contact cap when it moves downward.

The gas flow path is formed in the contact cap or an inner wall of the inner pipe and has a cross section area smaller than the cross section area of the gas guide flow path formed in the valve member.

The gas flow path is formed in an upward and downward direction or in a straight line shape or a maze shape in a center portion or an upper outer side of the contact cap.

The maze shaped cap is mounted in an upper surface of the contact cap, and a gas flow path passing through from the upper side to the lower is formed in a center portion of the same, and a maze shaped gas flow path is outwardly formed in a lower surface contacting with an upper surface of the contact cap in an outer side of the open groove.

A one-way check valve is further formed in a straight line shaped gas flow path, and the one-way check valve includes a valve body which moves only in a downward direction by means of an engaging protrusion formed in the gas flow path and opens a gap when moving in a downward direction, and a control plate which forms a gas guide hole in a center in a lower side of the gas flow path and controls a downward movement of the valve body.

An O-ring is engaged to an outer side of the head part of the piston rod for sealing, and a gas control flow path is formed in an inner wall of the inner pipe contacting with the O-ring of the head part for allowing gas to flow in upward and downward directions about the head part when passing the head part when the cylinder member is lowered.

The gas control flow path is formed in an inner wall of the inner pipe in one line or a plurality of lines, and the total cross section area of the gas control flow path is smaller than the cross section area of the gas guide flow path formed in the valve member.

### EFFECTS

The gas spring with a speed control function according to the present invention has the following advantages.

First, in a gas spring which is applied to control the height of a chair or the like, a user can sit on a chair in a more comfortable way without noticing any impact noise or with a smooth cushioning force by obtaining a slowdown operation a bottom dead center or a certain position when a seat plate is lowered.

Second, it is possible to enhance a performance of a gas spring by automatically controlling a lowering speed without a specific operation when a seat plate is lowered.

Third, a gas spring according to the present invention makes it possible to obtain a more comfortable sitting by continuously providing a cushioning force to a user at a bottom dead center when a seat plate is being lowered.

### BRIEF DESCRIPTION OF THE DRAWINGS

The present invention will become better understood with reference to the accompanying drawings which are given only by way of illustration and thus are not limitative of the present invention, wherein;

FIG. 1 is a vertical cross-sectional view illustrating a conventional gas spring and a use state of the same;

FIG. 2 is a vertical cross-sectional and partly enlarged view illustrating a gas spring with a speed control function according to the present invention;

FIG. 3 is a cross-sectional view illustrating a state that a slowdown guider is closely positioned as a cylinder member is lowered as shown in FIG. 2;

FIG. 4 is an enlarged and cross-sectional view of the portion “O” of FIG. 3;

FIG. 5 is a view of a comparison of the portions “A” and “B” when a gas flows as shown in FIG. 4;

FIG. 6 is a graph of an operation state of a gas spring according to the present invention;

FIG. 7 is a cross-sectional view illustrating a state that a maze-shaped cap is mounted on an upper side of a contact cap of a speed control guider according to another embodiment of the present invention;

FIG. 8 is a plane cross-sectional view taken along the line “C-C” of FIG. 7;

FIG. 9 is a vertical cross-sectional view illustrating a state that a gas control flow path is formed in an inner side pipe and a use state as another example of a gas spring according to the present invention;

FIG. 10 is a vertical cross-sectional view illustrating a state that a damper is removed from a lower side of an outer body of FIG. 9;

FIG. 11 is a plane cross-sectional view taken along the line “B-B” of FIG. 9;

FIG. 12 is a key element cross-sectional view illustrating a construction that a gas flow path is formed in the upper and lower portions in a center of a contact cap as another example of a gas spring according to the present invention;

FIG. 13 is a vertical cross-sectional and key element enlarged view illustrating a state that a spacer member is used in a form of protrusion as another example of a gas spring according to the present invention;

FIG. 14 is a view of another embodiment of FIG. 13; and

FIG. 15 is a view of further another embodiment of FIG. 13.

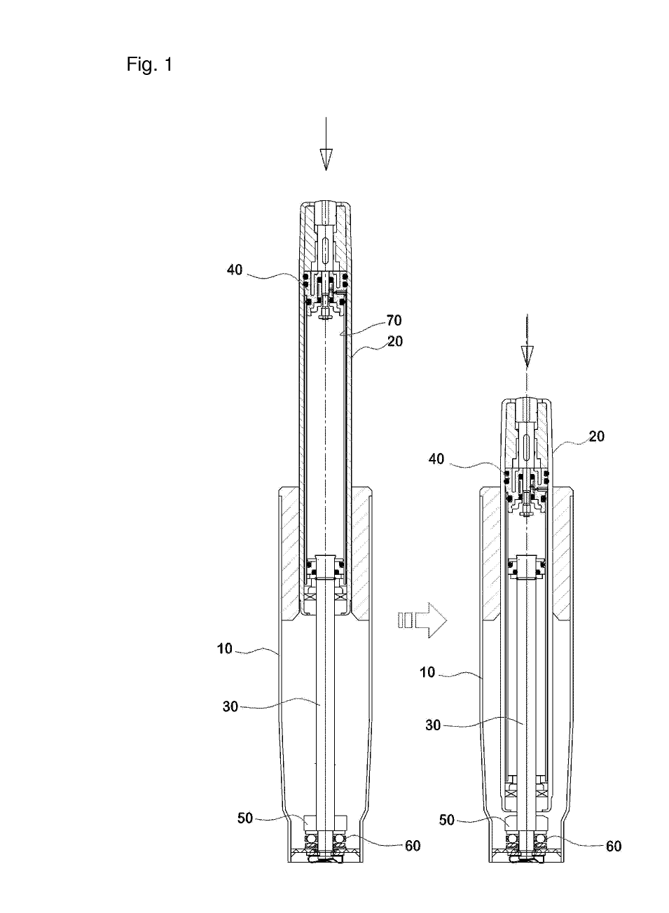

### MODES FOR CARRYING OUT THE INVENTION

The preferred embodiments of the present invention will be described with reference to the accompanying drawings.

### First Embodiment

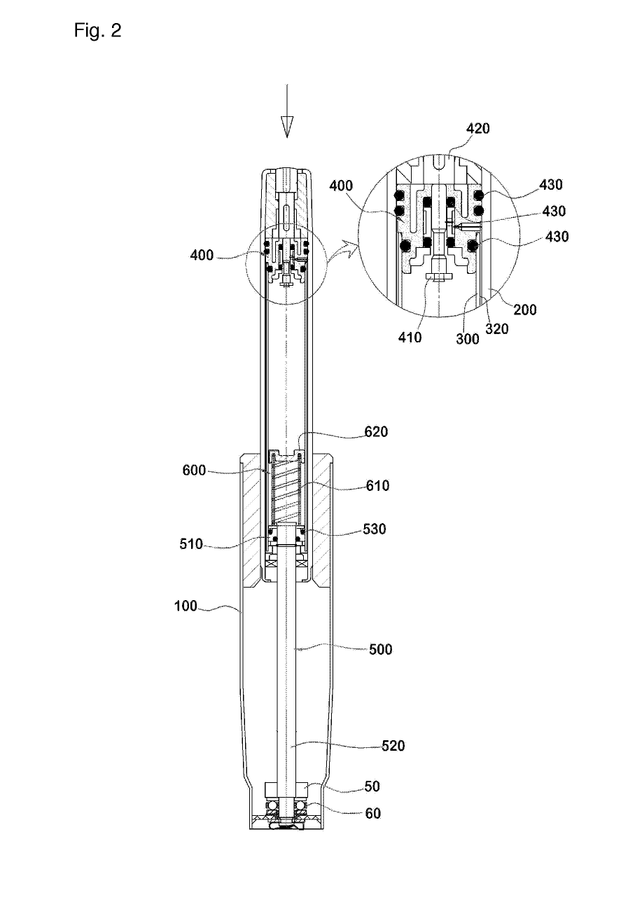

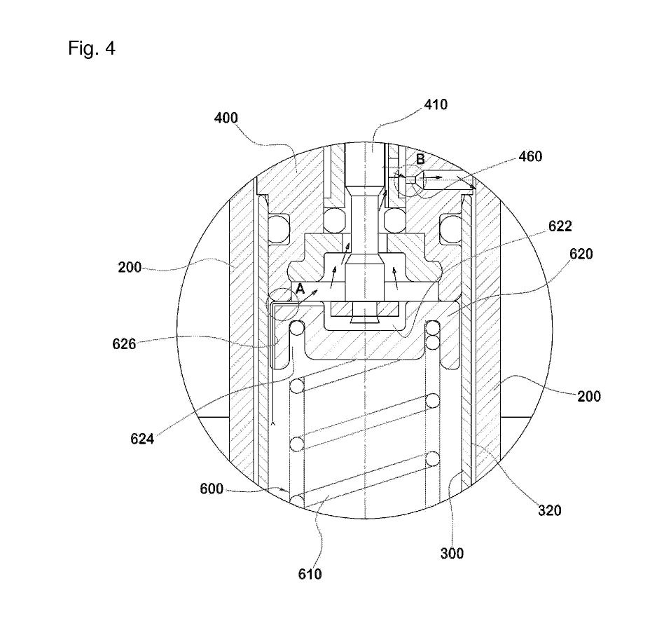

As shown in FIGS. 2 through 4, a gas spring with a speed control function according to the present invention comprises a hollow cylindrical outer body 100, a cylinder member 200 which is inserted into the interior of the outer body 100 in an up and down slide way, an inner side pipe 300 which is engaged to an inner wall of the cylinder member 200 and provides a gas flow path 320 between the inner wall and itself, a valve member 400 which is provided above the cylinder member 200 and the inner side pipe 300 for thereby controlling a gas flow in the gas flow path 320 with the help of a valve pin 410, a piston rod 500 of which a head part 510 corresponding to its one end slides in the interior of the inner side pipe 300 with the help of a gas pressure, and a rod part 520 corresponding to its other end is rotatably fixed in a bottom of the outer body 100, and a slowdown guider 600 disposed between the head part 510 of the piston rod 500 and the valve member 400 for thereby controlling a speed.

The outer body 100 has the same structure and function as in a conventional art and is equipped with a cylindrical structure opened an upward direction. A coating surface, preferably a nylon coating surface, is formed on its inner upper side for thereby slide-guiding the cylinder member 200. An inner bushing or the like can be fixedly engaged to an inner surface of the outer body 100 instead of a nylon coating surface.

The cylinder member 200 has a structure similar with the known structure and functions and is equipped with a piston rod 500 disposed therein and moves up and down depending on the flow of gas, with an outer circumferential surface of the cylinder member 200 being slide-engaged to an inner wall of the outer body 100, so the cylinder member moves up and down by a support of the piston rod 500 closely contacting with the ground.

The inner pipe 300 is formed in a cylindrical shape and is engaged with a certain gap spaced-apart from an inner wall of the cylinder member 200, so a gas flow path 320 is formed in an upward and downward direction between the cylinder member 200 and the inner pipe 300.

The gas moved through the gas flow path 320 is flown into the upper and lower side spaces formed about the head part 510 of the piston rod 500 disposed in the interior of the cylinder member 200 in the upper and lower sides of the cylinder member 200.

In the above structure, when a seating plate of a chair is engaged to an upper side of the cylinder member 200, it is possible to raise or lower the seating plate with the help of a gas pressure.

The valve member 400 is air-tightly engaged with an upper end of the inner pipe 300 in the inner side of the cylinder 200 and communicates with the gas flow path 320 for thereby selectively controlling the flow direction of gas.

Here, the valve member 400 includes a valve pin 410 inserted in an axial direction of the valve member 400 for thereby opening and closing a gas guide flow path 460 and an opening and closing lever or button 420 connected with an upper end of the valve pin 410 for thereby raising or lowering the valve pin 410 when it moves forwards and backwards, so that the upper space of the cylinder member 200 and the gas guide flow path 460 can communicate with each other, as a result of which the gas flows into the lower space of the cylinder member 200 through the gas flow path 320 formed between the cylinder member 200 and the inner pipe 400, whereby the cylinder member 200 can move up and down about the head part 510 of the piston rod 500.

In the valve member 400, an O-ring 430 is engaged between the cylinder member 200 and the inner pipe 300 and in a portion contacting with the valve pin 410.

The piston rod 500 has a structure similar with the known structure and function and is slide-engaged in the interior of the inner pipe 300, and the end of a lower rod part 520 passes through a bearing rotation member 600 and a support plate provided in the bottom of the outer body 100 and is rotatably engaged by means of a washer and a clip. The upper head part 510 slides upward and downward in the interior of the inner pipe 300.

An O-ring 530 is engaged to the head part 510, by means of which an inner wall of the inner pipe 300 can slide up and down air-tightly.

A damper 50 is provided in an upper surface of a rotation member 60 for absorbing impact while contacting with the cylinder member 200, and the damper 50 might be removed when a slowdown guider 600 is added.

As shown in FIGS. 2 through 5, the slowdown guider 600 is a key element of the first embodiment of the present invention and is disposed between the upper side of the head part 510 of the piston rod 500 and the lower surface of the valve member 400 for thereby controlling a lowering speed of the cylinder member 200. The slowdown guider 600 includes a contact cap 620 closely contacting with a lower surface of the valve member 400 for thereby controlling the flow of gas, and a spacer member 610 for maintaining a space between the contact cap 620 and the piston rod 500. As shown in FIGS. 2 through 5, the contact cap 620 includes an open groove 622 formed in an upper side of the same and opened upwardly in its center portion for preventing any interference with the valve pin 410 when contacting with the valve member 400. A ring groove 624 is formed in a lower surface of the same for allowing an upper end of the spacer member 610 formed in the slowdown guider 600 to be fixedly inserted into the ring groove 624. A gas flow path 626 is formed in an outer side and an upper side of the contact cap 620 for allowing gas to continuously flow and has a cross section area smaller than that of the gas guide flow path 460 of the valve member 400.

The contact cap 620 is preferably made of metal, synthetic resin, rubber, aluminum or a zinc material.

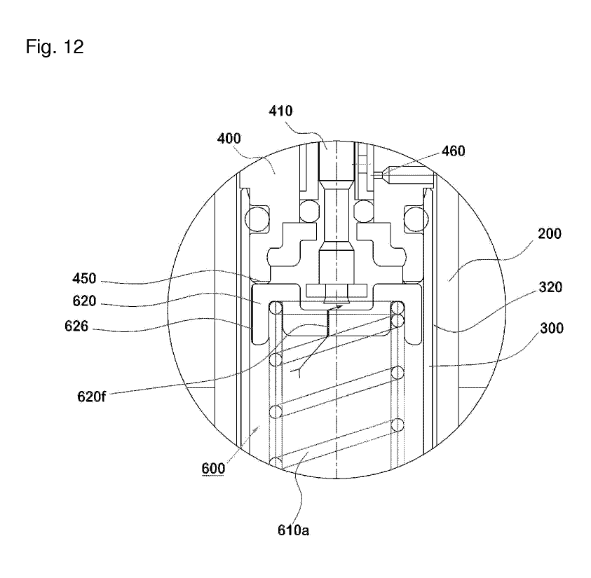

Referring to FIG. 12, as another example, alternative to the gas flow path 626 formed in the contact cap 620, a gas flow path 450 might be formed in a lower surface of the valve member 400. At this time the gas flows toward the gas flow path 450 while passing the outer side of the contact cap 620 and flows via the gas guide flow path 460 outwardly formed in the valve member 400. The gas flow path 450 has a cross section area smaller than that of the gas guide flow path 460 formed in an outer side of the valve member 400.

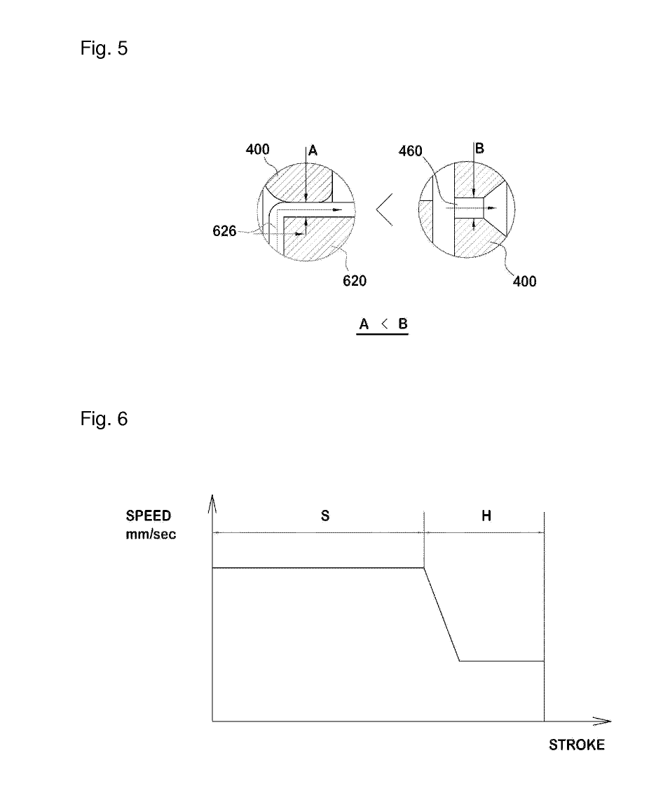

When the spacer member 610 belonging to the slowdown guider 600 is formed of a coil type spring 610a, as shown in FIG. 5, a metallic coil type spring 610 might be applied. Not shown in the drawings, when a rubber material is applied as a cushioning material, a hollow cushioning material is preferably used.

In the present invention, the spacer member 610 is formed of a coil type spring but such example is not limited thereto. Namely, various kinds of cushioning materials can be used for the same purpose.

For example, when the spacer member 610 is formed of a coil type spring, a contact cap 620 made of a synthetic resin material is preferably provided in such a manner that a lower end of the spacer member 610 is supported by an upper surface of the head part 510 of the piston rod 500, and an upper end of the same is stably supported by means of a lower surface of the valve member 400.

In the contact cap 620, an open groove 622 upwardly opened is formed in an upper surface of the same for preventing any interference with the valve pin 410 when contacting with the valve member 400, the open groove 622 being opened in an upward direction. A ring groove 624 is formed in a lower surface of the contact cap 620 for fixedly receiving an upper end of the spacer member 610 which corresponds to the slowdown guider 600. One or a plurality of gas flow paths 626 are formed in an outer surface and an upper surface of the contact cap 620, respectively, for thereby enhancing a continuous flow of gas.

The gas flow path 626 is configured to allow the gas stored in the upper side space of the cylinder member 200 to freely move and communicate between the upper and lower side spaces of the contact cap 620. The gas flow path 626 communicates with the gas guide flow path 460 formed in the valve member 400.

Here, it is preferred that the cross section area A of the gas flow path 626 formed in the contact cap 620 is smaller than the cross section area B of the gas guide flow path 460 formed in the valve member 400.

With the above construction, when the contact cap 620 closely contacts with a lower surface of the valve member 400, the gas can flow toward the gas guide flow path 460 of the valve member 400 only via the gas flow path 626 for thereby slow-downing the flow speed of gas.

The contact cap 620 is preferably formed of a rubber material pad. When it is made of a rubber material pad, it is preferred that a lower side is made of a harder material, and an upper side is made of a smoother material.

The contact cap 620 is separated into upper and lower sides. The upper side is made of a smoother material, and the lower side is made of a harder material. The upper and lower sides of the same are adhered or engaged for thereby forming the contact cap.

With the above construction, the upper surface of the contact cap 620 elastically contacts with the lower surface of the valve member 400.

Preferably, when molding the contact cap 620, the contact cap 620 might have different materials in its upper and lower sides. The upper side of the same can be made of a smoother material, and the lower side of the same can be made of a harder material.

FIG. 6 is a graph showing a moving speed of a seat plate when the seat plate is lowered in a gas spring according to the present invention, in which reference character S represents an initial lowering speed and H represents a process that a speed is controlled by means of a slowdown guider.

The operations of the gas spring with a speed control function according to the present invention will be described.

When assembling the gas spring with a speed control function according to the present invention, as shown in FIG. 2, the valve member 400 and the inner pipe 300 are assembled in the interior of the cylinder member 200, and the head part 510 of the piston rod 500 is slide-inserted into the interior of the inner pipe 300. The spacer member 610 is assembled on the upper surface of the head part 510, and the contact cap 620 is assembled thereon. The cylinder member 200 is engaged in the interior of the outer body 100, and the lower side of the rod part 520 of the piston rod 500 is rotatably engaged in the bottom surface of the outer body 100 via the rotation member 60 for thereby completing the manufacture of one gas spring. The finished gas spring is applied to a seat plate of a chair.

The operation of the gas spring with a speed control function according to the present invention will be described.

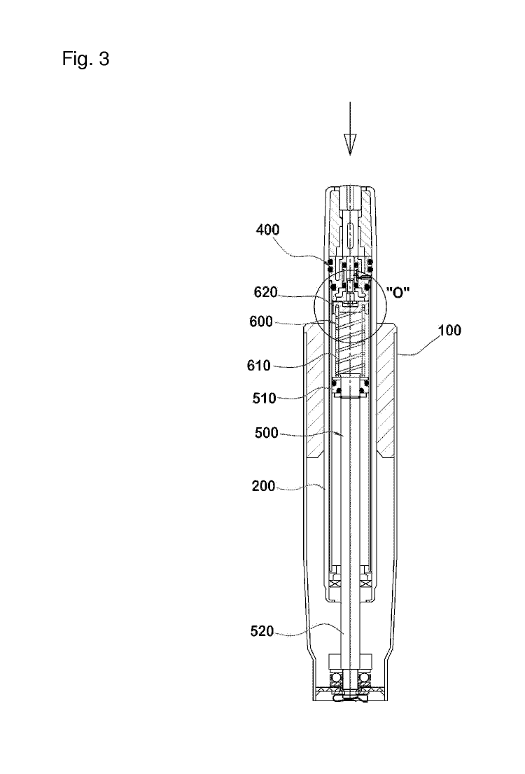

As shown in FIG. 2, in a state that the seat plate is in the raising and lowering mode, when the button 420 is pressed for a lowering operation, the valve pin 410 is lowered. The gas flows downward via the gas guide flow path 460. As shown in FIG. 3, the cylinder member 200, which is fixing the seat plate, is lowered, and when the cylinder member 200 moves down by a certain distance, as shown in FIGS. 3 and 5 the lower end of the cylinder member 200 is supported by means of an upper surface of the contact cap 620, and the lowering speed of the cylinder member 200 slowdowns by means of a limit in the flowing amount of the gas via the gas flow path 626, so that the cylinder member 200 slowly moves down. In this state, even when a user sits on a seat plate and handles to lower, the user does not have any impact at the bottom dead center, so the seat plate can be lowered in safe.

### Second Embodiment

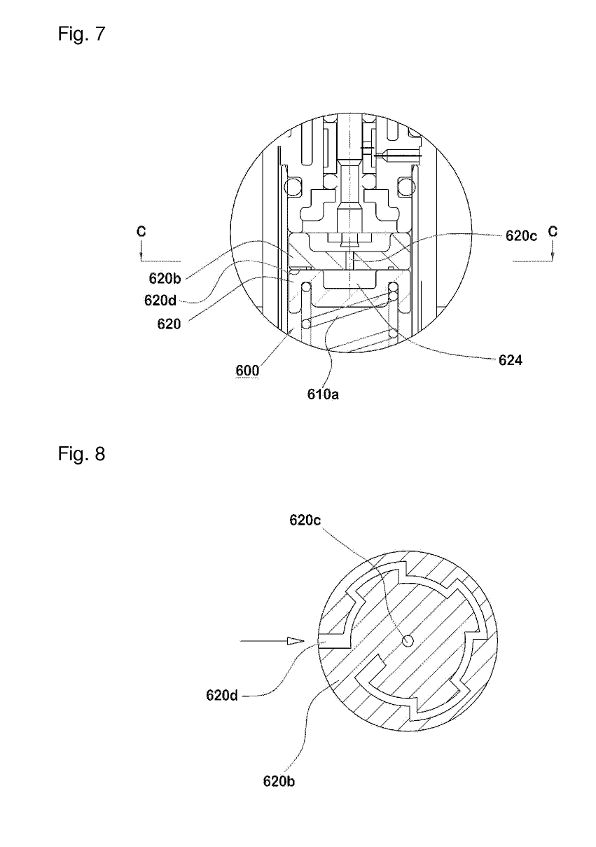

In the second embodiment of the present invention, a maze-shaped cap 620b is mounted on an upper side of the contact cap 620 as compared to the first embodiment of the present invention. As shown in FIGS. 7 and 8, a gas flow path 620c passing through from the upper side to the lower side, is formed in a center of the maze-shaped cap 620b, and the open groove 622 upwardly opened is formed in a center of the upper surface of the contact cap 620. A maze-shaped gas flow path 620d is formed in a lower surface of the maze-shaped cap 620b contacting with the upper surface of the contact cap 620.

When gas flows, the gas flows toward the gas flow path 620c formed in a center of the maze-shaped cap 620d and the maze-shaped gas flow path 620d formed in a lower surface of the maze-shaped cap 620b, and the flow speed of gas slowdowns in the contact section of the contact cap 620 and the maze-shaped cap 620b.

### Third Embodiment

According to the first and second embodiments of the present invention, an O-ring 530 is engaged in an outer side of the head part 510 of the piston rod 500 for sealing, a gas control flow path 700 is formed in an inner wall of the inner pipe 300 contacting with the O-ring of the head part 510 along a certain section with respect to the length of the inner pipe 300. When passing the head part 510, the gas can flow via the gas control flow path 700, so the seat plate can continuously receive an elastic repulsive force when the seat plate is positioned at the bottom dead center.

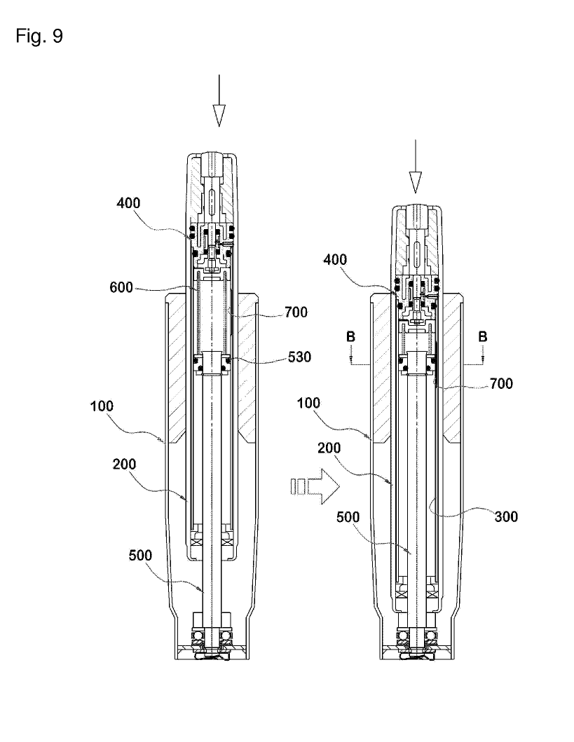

As shown in FIGS. 9 through 11, the gas control flow path 700 is formed in one line or a plurality of lines in the upper and lower longitudinal directions in the inner wall of the inner pipe 300. It is preferred that the total cross section area of the gas control flow path 700 is smaller than the cross section area of the gas flow path 460 formed in the valve member 400, so it is possible to control the lowering speed of the seat plate.

When the head part 510 passes the section in which the gas control flow path 700 is formed, the gas might flow via the gas control flow path 700, so when the seat plate is positioned at the bottom dead center, an elastic repulsive force can be continuously applied even when the valve pin 410 is closed. The user sitting on the seat plate can continuously receive a cushioning force.

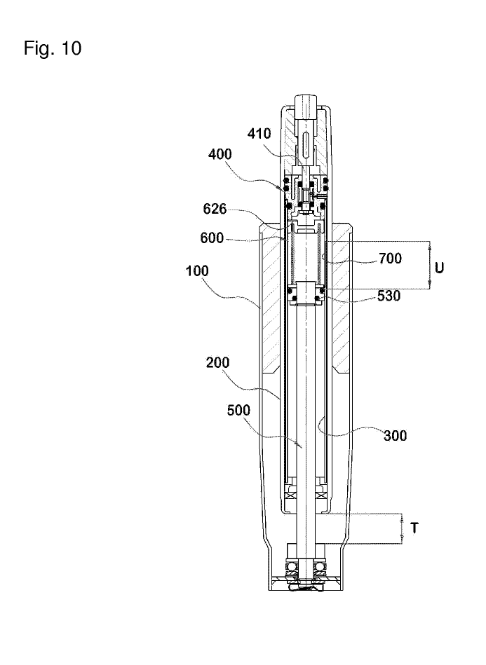

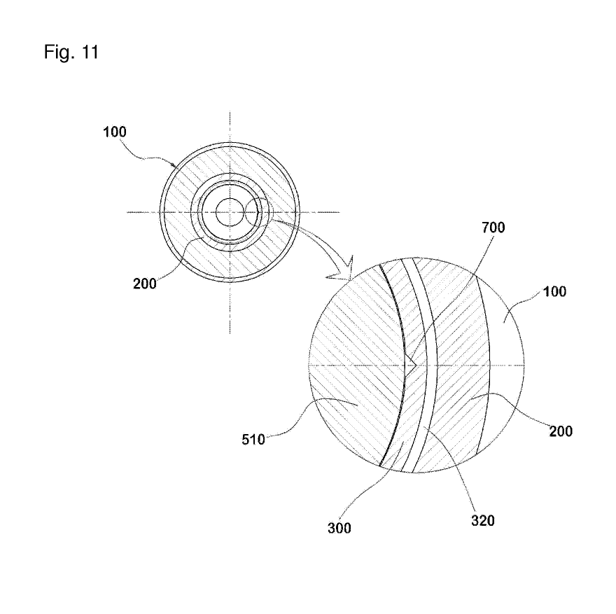

When the cylinder member 200 is lowered, a first lowering operation is performed with the help of gas cushioning function by the weight of the user, and as shown in FIG. 10, and the lowering speed slowdowns secondarily since the degree of the gas flow is limited via the gas control flow path 700 at the moment when the contact cap 620 contacts with the valve member 400. As shown in FIG. 10, when escaping the section T, the gas pass through the gas control flow path 700, so speed increases. At this moment, when the valve pin 410 is closed, the head part 510 of the piston rod 500 is positioned in the section U of the gas control flow path 700, so the user can sit with a certain space with the help of the spacer member 620 along with a cushioning effect by gas.

### Fourth Embodiment

As shown in FIG. 12, according to the first embodiment of the present invention, a gas flow path 620f is formed in a center portion of the contact cap 620. The gas flow path 620f is smaller than the gas flow path 460 of the valve member 400. When the seat plate is lowered as the above construction is applied to a chair, the lowering speed can slowdown at the moment when the contact cap 620 of the slowdown guider 600 is contacted.

### Fifth Embodiment

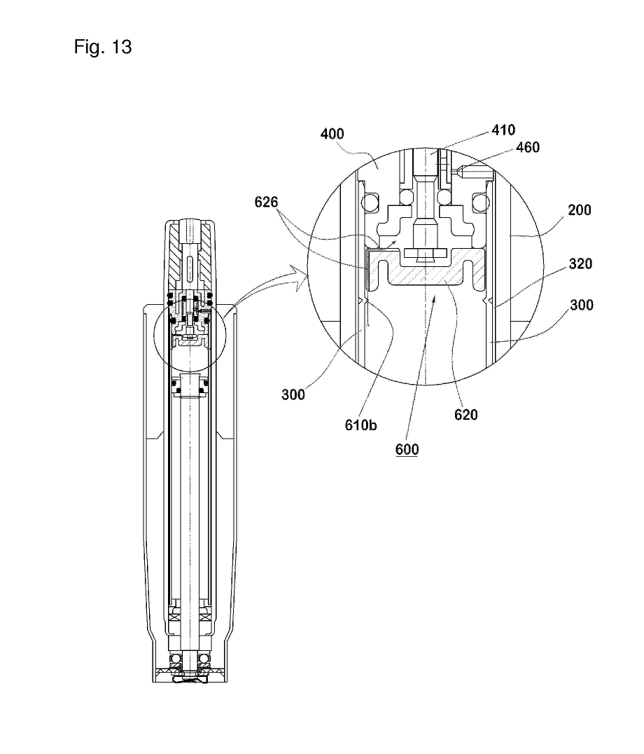

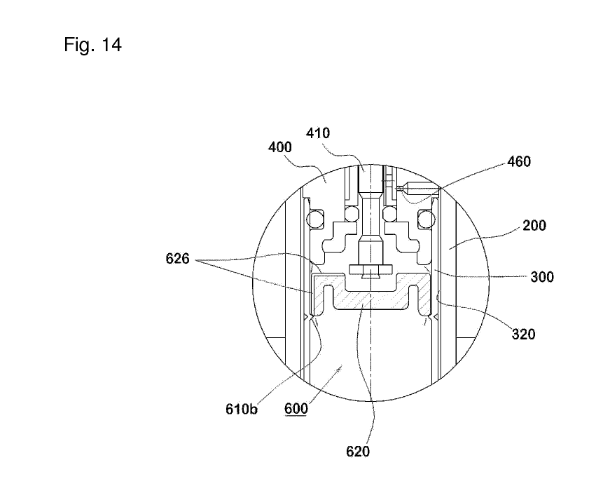

As shown in FIG. 13 or 14, another example of the slowdown guider 600 of the first embodiment of the present invention is shown. The spacer member 610 applied so as to control the up and down movements of the contact cap 620 is formed of a protrusion 610b disposed in an upper inner wall of the inner pipe 300. The protrusion 610b might be formed like the protrusion 610b is protruded from the inner side of the inner pipe 300 by pressing an outer diameter of the inner pipe 300. Alternative to the above, an additional member might be fixed in an inner wall of the inner pipe 300.

As the space between the contact cap 610 and the lower surface of the valve member 400 is narrowed by means of the protrusion 610b, it is possible to make slower the gas flow speed in a certain section or continuously.

### Sixth Embodiment

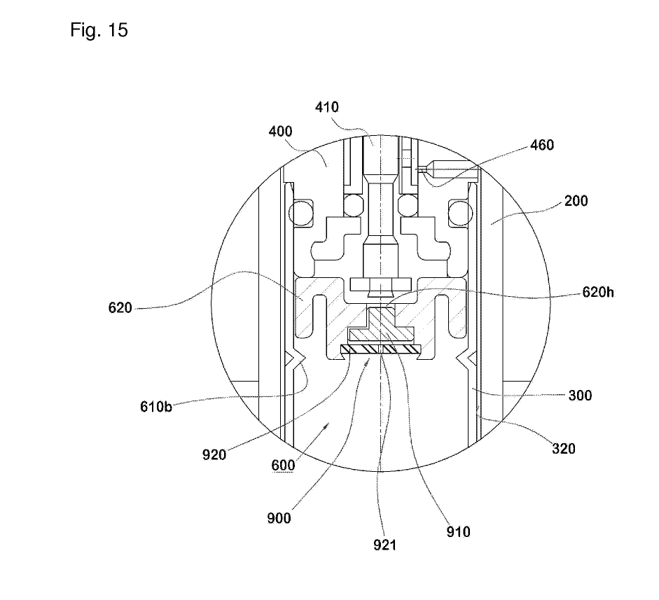

As shown in FIG. 15, it is another example of the fifth embodiment of the present invention. A gas flow path 620h having a diameter larger than the gas flow path 620f is formed in a center portion of the contact cap 620. A check valve 900 is disposed in the gas flow path 620h.

The check valve 900 disposed in the gas flow path 620h allows the gas to flow only one direction from the upper direction to the lower direction.

The check valve 900 is formed of a valve body 910 for opening a gap when gas flows in the downward direction as the gas flows in only the downward direction by means of an engaging protrusion formed in the gas flow path 620h, and a control plate 920 which forms a gas guide hole 921 in a lower side of the gas flow path 620h at a center portion for thereby controlling a downward movement of the valve body 910.

### INDUSTRIAL APPLICABILITY

As described above, the present invention can be applied to a structure such as a chair, a shelf or the like which is intended to move up and down.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a gas spring which includes a cylinder member 200 slide-engaged in upward and downward directions in the interior of an outer body 100, an inner pipe 300 which is engaged to an inner wall of the cylinder member 200 and forms a gas flow path 320 in upward and downward directions between itself and the inner wall of the same, a valve member 400 which is provided in the upper sides of the cylinder member 200 and the inner pipe 300 and includes a gas guide flow path 460 for controlling the flow of gas via the gas flow path 320 depending on an operation of a valve pin 410, and a piston rod 500 of which a head part 510 is air-tightly slide-engaged in the interior of the inner pipe 300, and a rod part is vertically rotatably engaged to a bottom of the outer body 100, a gas spring with a speed control function, comprising:
a speed control guider 600 disposed between a head part 510 provided on an upper side of the piston rod 500 and the valve member 400 for thereby controlling the flow of a gas via a gas flow path 626 when the cylinder member 200 is lowered, which leads to controlling a lowering speed.

2. The gas spring of claim 1, wherein said speed control guider 600 includes:
a contact cap 620 which forms a gas flow path 626 for flowing gas and selectively contacts in a upper side or a lower side in a lower surface of the valve member 400; and
a spacer member 610 which is disposed between the lower surface of the contact cap 620 and the piston rod 500 for thereby maintaining a certain space.

3. The gas spring of claim 2, wherein an open groove 622 upwardly open is formed in an upper surface of a body belonging to the contact cap 620 for thereby guiding a valve pin 410 without any interference when contacting with the valve member 400, and a ring groove 624 is formed in a lower surface and is downwardly open for fixedly inserting an upper end of the spacer member 610.

4. The gas spring of claim 3, wherein said body belonging to the contact cap is made of one selected from the group consisting of metal, aluminum, zinc, synthetic resin and rubber.

5. The gas spring of claim 3, wherein said body belonging to the contact cap 620 is formed of an upper part and a lower part of which the lower part is made of a harder material and the upper part is made of a smoother material.

6. The gas spring of claim 3, wherein said spacer member 610 is formed of a coil type spring 610a or a rubber hollow cushioning material.

7. The gas spring of claim 2, wherein said spacer member 610 is formed of a protrusion 610b protruded from an inner wall of the inner pipe 300 for controlling a downward movement of the contact cap 620 when it moves downward.

8. The gas spring of claim 2, wherein a gas flow path formed in the contact cap 620 is further formed in a lower surface of the valve member 400, so that the total cross section area of the gas flow path is smaller than the cross section area of the gas guide flow path 460 formed in the valve member 400.

9. The gas spring of claim 2, wherein said gas flow path 626 is formed to communicate from the upper side to the lower side in at least one portion among a center portion of the contact cap 620 and an outer side of the contact cap 620.

10. The gas spring of claim 8, wherein said gas flow path 626 is formed in a straight line shape or a maze shape.

11. The gas spring of claim 10, wherein said gas flow path 626 communicates via an additional maze shaped cap 626b in a maze shape.

12. The gas spring of claim 11, wherein said maze shaped cap 620b is mounted in an upper surface of the contact cap 620, and a gas flow path 620c passing through from the upper side to the lower is formed in a center portion of the same, and a maze shaped gas flow path 620d is outwardly formed in a lower surface contacting with an upper surface of the contact cap 620 in an outer side of the open groove 624.

13. The gas spring of claim 10, wherein a one-way check valve 900 is further formed in a straight line shaped gas flow path.

14. The gas spring of claim 13, wherein said one-way check valve 900 includes:
a valve body which moves only in a downward direction by means of an engaging protrusion formed in the gas flow path 620h and opens a gap when moving in a downward direction, and a control plate 920 which forms a gas guide hole 921 in a center in a lower side of the gas flow path 620h and controls a downward movement of the valve body 910.

15. The gas spring of claim 1, wherein an O-ring 530 is engaged to an outer side of the head part 510 of the piston rod 500 for sealing, and a gas control flow path 700 is formed in an inner wall of the inner pipe 300 contacting with the O-ring 530 of the head part for allowing gas to flow in upward and downward directions about the head part when passing the head part when the cylinder member 200 is lowered.

16. The gas spring of claim 15, wherein said gas control flow path 700 is formed in an inner wall of the inner pipe 300 in one line or a plurality of lines, and the total cross section area of the gas control flow path 700 is smaller than the cross section area of the gas guide flow path 460 formed in the valve member 400.

17. The gas spring of claim 8, wherein said gas flow path 626 is formed to communicate from the upper side to the lower side in at least one portion among a center portion of the contact cap 620 and an outer side of the contact cap 620.
